(19) United States
(12) Patent Application Publication
(10) Pub. No.: US 2007/0289399 A1
(43) Pub. Date: Dec. 20, 2007

(54) DUAL CLUTCH TRANSMISSION APPARATUS WITH PARKING LOCK FUNCTION

(75) Inventors: Toshio Tanba, Kariya-shi (JP); Shiro Ogami, Kariya-shi (JP)

Correspondence Address: BUCHANAN, INGERSOLL & ROONEY PC, POST OFFICE BOX 1404, ALEXANDRIA, VA, 22313-1404, US

(73) Assignee: AISIN AI Co., Ltd., Nishio-shi (JP)

(21) Appl. No.: 11/763,852

(22) Filed: Jun. 15, 2007

(30) Foreign Application Priority Data
Jun. 16, 2006 (JP) 2006-167537

(51) Int. Cl. F16H 3/08

(52) U.S. Cl. 74/330

(57) ABSTRACT

A dual clutch transmission apparatus with a parking lock function includes a first and a second input shafts, a first and a second counter shafts, a dual clutch including a first and a second clutches, a first gear change mechanism having first plural gear trains including a 1st shift stage gear train, a second gear change mechanism having second plural gear trains including a reverse shift stage gear train, an output shaft, a first gear and a second gear provided at one of the first and the second input shafts and forming the 1st shift stage gear train and the reverse shift stage gear train relatively, a plurality of engaging members including a first engaging member and a reverse engaging member, wherein, during a parking operation, the first engaging member and the reverse engaging member are in the engaged states simultaneously so that a parking lock is executed.

### CROSS REFERENCE TO RELATED APPLICATIONS

This application is based on and claims priority under 35 U.S.C. § 119 to Japanese Patent Application 2006-167537, filed on Jun. 16, 2006, the entire content of which is incorporated herein by reference.

### FIELD OF INVENTION

A present invention relates to a dual clutch transmission apparatus with a parking lock function by which wheels are locked automatically when the vehicle is parked.

### BACKGROUND

In JP H07(1995)-137555A (paragraphs 7-8), an example of a parking lock device for automatically locking wheels when a vehicle having an automatic transmission is parked is disclosed. The parking lock device disclosed in the specification includes a parking lock gear, which is directly connected to an output shaft of a transmission linked to driving wheels, and a parking lock pawl facing to the parking lock gear. In this configuration, when a shift lever is set to a parking range, a park lock cam moves to a position where the park lock cam contacts with the parking lock pawl so that a tooth portion of the parking lock pawl is engaged with a bottom portion of the parking lock gear. As a result, the driving wheels of the vehicle are locked. When the shift lever is operated, the park lock cam is moved by means of a compression coil spring. In a case where the tooth portion of the parking lock pawl is not engaged with the bottom portion of the parking lock gear when the shift lever is operated, the tooth portion of the parking lock pawl is elastically press-fitted to a top portion of the parking lock gear by a biasing force of the compression coil spring. When the driving wheels of the vehicle are moved slightly, the parking lock gear is also rotated, and then the tooth portion of the parking lock pawl is engaged with the bottom portion of the parking lock gear. The compression coil spring moves in the position where the compression coil spring contacts with the parking lock pawl so that the compression coil spring supports the engagement between the parking lock pawl and the parking lock gear. As a result, the driving wheels of the vehicle are locked by the tooth portion of the parking lock pawl being engaged with the bottom portion of the parking lock gear. On the other hand, when the shift lever is moved to other ranges from the parking range, the parking lock pawl moves backwards from a position where the parking lock pawl is engaged with the parking lock gear in order to disengage the parking lock pawl from the parking lock gear.

The parking lock device disclosed in the specification requires the parking lock gear, the parking lock pawl and the park lock cam for operating the parking lock gear and the parking lock pawl, and the like. A need thus exists to provide a dual clutch transmission apparatus with a parking lock function by utilizing engaging members and gear trains of the dual clutch transmission apparatus. By doing so, the present invention may not need additional components for the parking lock mechanisms.

### SUMMARY OF THE INVENTION

According to an aspect of the present invention, a dual clutch transmission apparatus with a parking lock function includes a first input shaft, a second input shaft arranged coaxially with the first input shaft, a first counter shaft arranged in parallel with the first and the second input shafts, a second counter shaft arranged in parallel with the first and second input shafts, a dual clutch including a first clutch and a second clutch, the first clutch transmitting rotational torque from a power source to the first input shaft and the second clutch transmitting the rotational torque from the power source to the second input shaft, a first gear change mechanism provided between the first and the second input shafts and the first counter shaft and having first plural gear trains, the first plural gear trains including a 1st shift stage gear train, a second gear change mechanism provided between the first and the second input shafts and the second counter shaft and having second plural gear trains, the second plural gear trains including a reverse shift stage gear train, an output shaft connected to the first and the second counter shafts for transmitting the rotational torque from the power source to a driving wheel, a first gear provided at one of the first and second input shafts and forming the 1st shift stage gear train, a second gear provided at one of the first and second input shafts and forming the reverse shift stage gear train, a plurality of engaging members each provided in connection with each of the shift stage gear trains and being in engaged/disengaged state in order to switch torque transmission of the each shift stage gear train, the plurality of engaging members including a first engaging member being in an engaged state in order to transmit torque at the 1st shift stage gear train and the plurality of engaging members including a reverse engaging member being in an engaged state in order to transmit torque at the reverse shift stage gear train wherein, during a parking operation, the first engaging member and the reverse engaging member are in the engaged states simultaneously so that a parking lock is executed.

### BRIEF DESCRIPTION OF THE DRAWINGS

The foregoing and additional features and characteristics of the present invention will become more apparent from the following detailed description considered with reference to an accompanying drawings, wherein:

FIG. 1 is a view schematically illustrating an entire structure of a dual clutch transmission apparatus with parking lock function according to an embodiment of the present invention;

FIG. 2 is a sectional view illustrating an example of a switching clutch indicated in FIG. 1; and

FIG. 3 is a table explaining a shift operation in accordance with FIG. 1.

### DETAILED DESCRIPTION

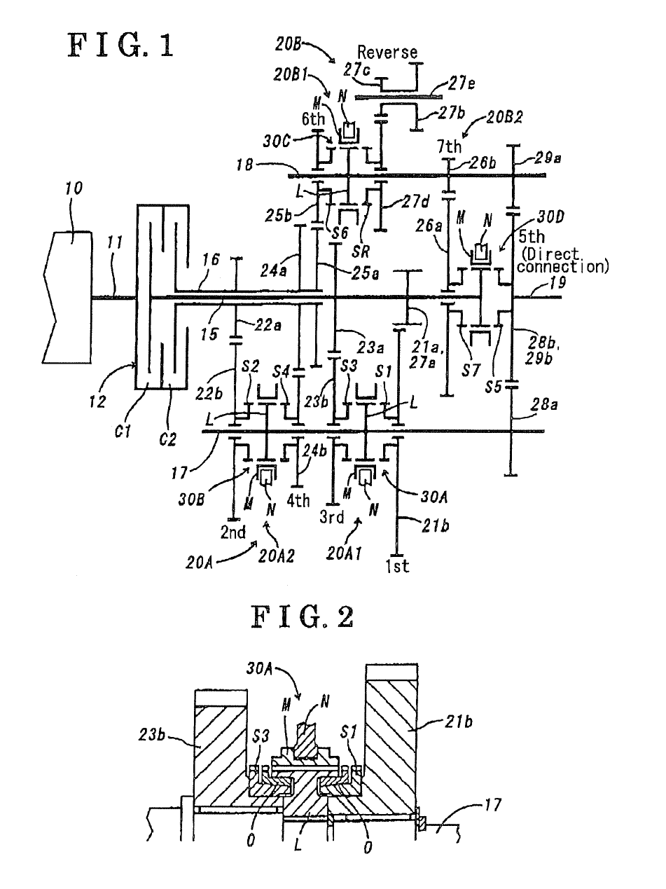

An embodiment of the present invention will be explained in accordance with the attached drawings. According to an embodiment of the present invention, the present invention is applied to a dual clutch transmission apparatus having, for example, seven forward shift stages and one reverse shift stage. A shown in FIG. 1, the dual clutch transmission apparatus according to the embodiment includes a first input shaft 15, a second input shaft 16 formed in a hollow shape and rotatably surrounding the first input shaft 15, a first counter shaft 17 arranged in parallel with the first input shaft 15 and the second input shaft 16, a second counter shaft 18 arranged in parallel with the first input shaft 15 and the second input shaft 16, and an idle shaft 27e for reverse operation arranged in parallel with the second counter shaft 18. The first input shaft 15 penetrates through the second input shaft 16 formed in a hollow shape and extends in a rearward direction. The dual clutch transmission apparatus further includes an output shaft 19, which is coaxially arranged at end portion of the first input shaft 15. The output shaft 19 is linked to driving wheels. A first functional clutch (first clutch) C1 and a second frictional clutch (second clutch) C2 are rotatably actuated by a power source 10, such as an engine, via a driving shaft 11. The first input shaft 15, which is connected to the first frictional clutch C1, is rotatably driven in response to the operation of the first frictional clutch C1. Likewise, the second input shaft 16, which is connected to the second frictional clutch C2, is rotatably driven in response to the operation of the second frictional clutch C2. The first frictional clutch C1 is controlled to establish or interrupt a path for transmitting torque A, for example, to the odd gears (1st, 3rd, 5th and 7th), while the second frictional clutch C2 is controlled to establish or interrupt a path for transmitting torque B, for example, to the even gears (2nd, 4th and 6th). When a vehicle is driven in a normal condition, the first and second frictional clutches C1 and C2 of the dual clutch mechanism 12 are controlled by the control device (not shown) in a manner that; 1) during a shift operation, the first and the second clutches are in partial clutch engagement state, which results in the torque A being increased and the torque B being decreased, and vice versa, 2) and after the shift operation has ended, the first frictional clutch C1 is completely engaged, which results in the torque A of the first functional clutch C1 reaching a predetermined maximum value while the second clutch C2 is disengaged and the torque B corresponds to the second clutch falling down to 0 value, and vice versa.

A first gear change mechanism 20A is positioned between the first counter shaft 17 and the first and the second input shafts 15 and 16. A second gear change mechanism 20B is placed between the first and the second input shafts 15, 16 and the second counter shaft 18. A fourth switching clutch 30D (switching clutch 3) is placed between the first input shaft 15 and the output shaft 19, which are coaxially arranged to each other. The fourth switching clutch 30D connects or disconnects the shafts 15 and 19. The first counter shaft 17 is linked to the output shaft 19 via a first reduction gear train (28a, 28b). The second counter shaft 18 is linked to the output shaft 19 via a second reduction gear train (29a, 29b). A driven gear is commonly used by the first and the second reduction gear trains. However, for convenience, the driven gear is described differently as the driven gear 28b and the driven gear 29b. The driven gear is fixed at a front end of the output shaft 19.

The first gear change mechanism 20A includes first plural gear trains. The first gear change mechanism 20A includes a first gear switching unit 20A1, which is provided at the first counter shaft 17 and positioned between the first input shaft 15 and the first counter shaft 17, and a second gear switching unit 20A2, which is provided at the first counter shaft 17 and positioned between the second input shaft 16 and the first counter shaft 17. The first gear switching unit 20A1 includes a 1st shift stage gear train (21a, 21b), a 3rd shift stage gear train (23a, 23b) and a first switching clutch 30A. The 1st shift stage gear train (21a, 21b) includes a driving gear 21a, which serves as a first gear, fixed at the first input shaft 15 and a driven gear 21b rotatably provided at the first counter shaft 17. The driving gear 21a is also described as a reverse driving gear 27a, which serves as a second gear. Further, the 3rd shaft stage gear train (23a, 23b) includes a driving gear 23a fixed on the first input shaft 15 and a driven gear 23b rotatably mounted onto the first counter shaft 17.

A known synchromesh mechanism is adapted to the first switching clutch 30A. As shown in FIG. 1 and FIG. 2, the synchromesh mechanism incorporates therein a clutch hub L spline-engaged with the first counter shaft 17 arranged between the 1st shift stage driven gear 21b and the 3rd shift stage driven gear 23b, a 1st shift stage engaging member S1 press-fitted to the 1st shaft stage driven gear 21b, a 3rd shift stage engaging member S3 press-fitted to the 3rd shift stage driven gear 23b, a synchronizer ring O interposed between the clutch hub L and each of the shift stage engaging member S1 end S2, and a sleeve M spline-engaged with an outer periphery of the clutch hub L so as to be movable in an axial direction. The synchromesh mechanisms connect in turns either the driven gear 21b or 23b to the first counter shaft 17 or to simultaneously disconnect both of the driven gears 21b and 23b therefrom. The sleeve M of the first switching clutch 30A, when being located in a neutral position as shown in FIG. 1, is engaged neither with the engaging member S1 nor with the engaging member S3. However, once the sleeve M is shifted towards the driven gear 21b of the 1st shift stage by a shift fork N fixed at a peripheral annular-shaped groove of the sleeve M, the sleeve M is firstly spline-engaged with the synchronizer ring O at the side of the first stage driven gear 21b, wherein rotation of the first counter shaft 17 is synchronized with rotation of the 1st shift stage driven gear 21b. The sleeve M is then spline-engaged with peripheral teeth of the 1st shift stage engaging member S1, wherein the first counter shaft is connected integrally with the 1st shift stage engaging member S1 so as to establish the 1st shift stage. Meanwhile, once the sleeve M is shifted towards the driven gear 23b of the 3rd shift stage by the shift fork N, rotation of the first counter shaft 17 is synchronized with rotation of the 3rd shift stage driven gear 23b, and then the first counter shaft 17 is connected integrally with the 3rd shift stage driven gear 23b so as to establish the 3rd shift stage.

The second gear switching unit 20A2 comprises a 2nd shift stage gear train (22a, 22b), a 4th shift stage gear train (24a, 24b) and a second switching clutch 30B. Similarly to the case of the above-mentioned first gear switching unit 20A1, the 2nd shift stage gear train (22a, 22b) is configured with a driving gear 22a firmly attached to the second input shaft 16 and a driven gear 22b rotatably provided at the first counter shaft 17. The 4th shift stage gear train (24a, 24b) is configured with a driving gear 24a firmly attached to the second input shaft 16 and a driven gear 24b rotatably provided at the first counter shaft 17. The second switching clutch 30B is a synchromesh mechanism configured so as to connect in turns either the driven gear 22b or 24b to the first counter shaft 17 or to simultaneously disconnect both of the driven gears 22b and 24b therefrom. The structure of the second switching clutch 30 is the same as the one of the first switching clutch 30A, except that a 2nd shift stage engaging member S2 and a 4th shift stage engaging member S4 are fixed to the 2nd shift stage driven gear 22b and the 3rd shift stage driven gear 24b, respectively. Likewise as the first switching clutch 30A, the second switching clutch 30B, when being located in a neutral position shown in FIG. 1, is engaged with none of the engaging members S2 and S4. However, once a sleeve M of the second switching clutch 30B is shifted towards the 2nd shift stage driven gear 22b by a shift fork N fixed at the sleeve M, rotation of the first counter shaft 17 is synchronized with rotation of the 2nd shift stage driven gear 22b, and the first counter shaft 17 is integrally connected with the 2nd shift stage driven gear 22b so as to establish the 2nd shift stage. Meanwhile, once the sleeve M is shifted towards the 4th shift stage driven gear 24b by the shift fork N, rotation of the first counter shaft 17 is synchronized with rotation of the 4th shift stage driven gear 24b, and then the first counter shaft 17 is connected integrally to the 4th shaft stage driven gear 24b so as to establish the 4th shift stage.

The second gear change mechanism 20B3 includes second plural gear trains. The second gear change mechanism 20B includes a third gear switching unit 20B1 arranged between the first and the second input shafts 15, 16 and the second counter shaft 18, and a fourth gear switching unit 20B2 arranged between the first input shaft 15 and the second counter shaft 18. The third gear switching unit 20B1 includes a 6th shift stage gear train (25a, 25b), a reverse shift stage gear train (27a, 27b, 27c, 27d), and a third switching clutch 30C. The 6th shift stage gear train (25a, 25b) is configured with a driving gear 25a firmly attached to the second input shaft 16 and a driven gear 25b rotatably provided at the second counter shaft 18. The reverse shift stage gear train is configured with a driving gear 27a (which is also described as the 1st shift stage driving gear 21a) firmly attached to the first input shaft 15, a driven gear 27d rotatably provided at the second counter shaft 18, and a pair of idle gears (27b, 27c) integrally formed with each other. The idle gears (27b, 27c) are rotatably arranged on the idle shaft 27e for a reverse operation and further connect the driving gear 27a with the driven gear 27d. Substantively, the synchromesh mechanism is adapted to the third switching clutch 30C. The third switching clutch 30C is configured so as to connect in turns either the driven gear 25b or 27d to the second counter shaft 18 or to disconnect both of the driven gears 25b and 27b therefrom. The third switching clutch 30C, when being located in a neutral position shown in FIG. 1, is engaged with none of engaging members S6 and SR. However, once a sleeve M of the third switching clutch 30C is shifted towards the 6th shift stage driven gear 25b by a shift fork N, rotation of the second counter shaft 17 is synchronized with rotation of the 6th shift stage driven gear 25b, and then the second counter shaft 17 is integrally connected with the 6th shift stage driven gear 25b so as to establish the 6th shift stage. Meanwhile, once the sleeve M is shifted towards the reverse driven gear 27b, rotation of the second counter shaft 18 is synchronized with rotation of the reverse driven gear 27b, and then the second counter shaft 18 is integrally connected to the reverse driven gear 27b so as to establish the reverse shift stage.

The fourth gear switching unit 2032 includes a 7th shift stage gear train (26a, 26b) and a part of the fourth switching clutch 30D. The 7th shift stage gear train (26a, 26b) is configured with a driving gear 26a rotatably provided at a rear portion of the first input shaft 15 and a driven gear 26b firmly attached to the second input shaft 18. The fourth switching clutch 30D is arranged between the driving gear 26a of the 7th shift stage gear train (26b, 26b) and the driven gear (28b, 29b). The driving gear 26a of the 7th shift stage gear train (26a, 26b) is rotatably provided at the rear portion of the first input shaft 15. The driven gear (28b, 29b) is commonly used by the first and the second reduction gear trains and is coaxially fixed to the front portion of the output shaft 19. The fourth switching clutch 30D is structured with the synchromesh mechanisms, whose structure is the same as that of the first switching clutch 30A. However, the fourth switching clutch 30D differs from the first switching clutch 30A in terms of a clutch hub L being fixed on the rear portion of the first input shaft 15, a fifth engaging member S5 being fixed on the driven gear (28b, 29b) commonly used by the first and the second reduction gear trains (28a, 28b and 29a, 29b) and a seventh engaging member S7 being fixed on the 7th shift stage driving gear 26a. The fourth switching clutch 30D is engaged with none of the engaging member S5, S7, when the fourth switching clutch 30D is located in a neutral position. However, when a sleeve M of the fourth switching clutch 30D is shifted towards the 7th shift stage driven gear 26a by means of a shift fork N, rotation of the first input shaft 17 is synchronized with rotation of the 7th shift stage driving gear 26a so as to establish the 7th shift stage. Meanwhile, when the sleeve M is shifted towards the driven gear (28b, 29b) commonly used by the first and the second reduction gear trains, rotation of the input shaft 15 is synchronized with rotation of the output shaft 19, and the input shaft 15 is connected integrally with the output shaft 19 in order to establish the 5th shift stage.

According to the embodiment, the number of teeth of each gear used for each shift stage, the reverse shift stage and reduction gear trains is designed so that a gear ratio of each shift stage achieves a predetermined value. When the vehicle is driven at the 1st shift stage, a reduction gear ratio between the first input shaft 15 and the output shaft 19 will be the largest, compared to a case where other shift stages for forward movement are selected. When the vehicle reverses in the reverse shift stage, the reduction gear ratio between the first input shaft 15 and the output shaft 19 is equal to or more than the reduction gear ratio established when the vehicle is driven with the 1st shift stage. Further, when the vehicle reverses with the reverse shift stage, a sign indicating the direction of the shaft rotation of the first input shaft 15 and the output shaft 19 is described the other way around from the rotational direction of the shaft rotating when the vehicle is driven with the 1st shift stage. Additionally, when the vehicle is driven the 5th shift stage, as the first input shaft 15 is directly connected to the output shaft 19, a speed change ratio of the 5th shift stage becomes one.

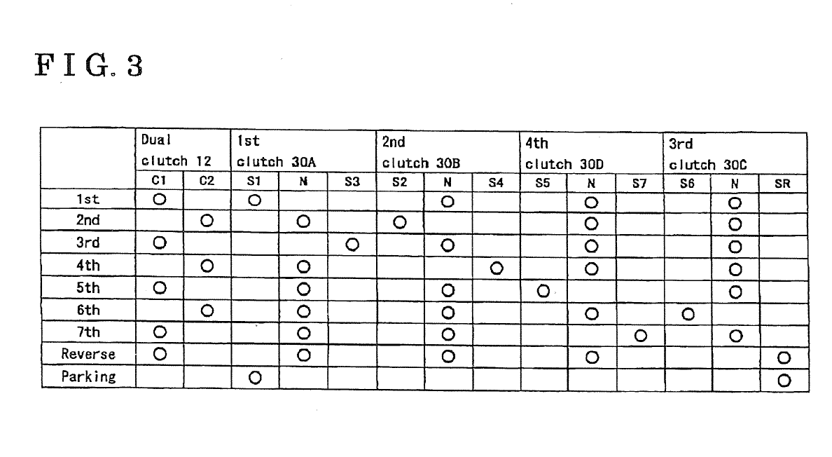

The control device of the dual clutch transmission apparatus in the embodiment operates the first and the second frictional clutches C1, C2 of the dual clutch 12, and also operates the first switching clutch 30A, the second switching clutch 30B, the third switching clutch 30C and the fourth switching clutch 30D depending on a condition of the vehicle, such as an accelerator opening degree, an engine rotational speed, a speed of the vehicle, and the like. When the dual clutch transmission apparatus is not operated, the first and the second frictional clutches C1 and C2 of the dual clutch 12 are both disengaged, which results in the first switching clutch 30A, the second switching clutch 30B, the third switching clutch 30C and the fourth switching clutch 30D being located in a neutral position. When the engine 10 is activated while the vehicle is parked, and then the shift lever of the dual clutch transmission apparatus (not shown) is set to be at the forward movement position, for example, to establish the 1st shift stage as shown in FIG. 3, the control device detects the aforementioned state of the vehicle, engages the first engaging member S1 and further controls the other clutches to be at a neutral position. Once a rotational speed of the engine 10 exceeds a predetermined low rotational speed in response to an increase in an accelerator opening degree, the control device gradually increases an engagement force of the first frictional clutch C1 of the dual clutch 12 in accordance with an amount of the accelerator opening degree. Accordingly, driving torque of the drive shaft 11 is transmitted from the first frictional clutch C1 to the output shaft 19 via the 1st shift stage gear train (21a, 22b) (the driving gear 21a also functions as the rear driving gear 27a), the first switching clutch 30A, the first counter shaft 17 and the first reduction gear train (28a, 28b). As a result, the vehicle starts running at the 1st shift stage.

When the condition of the vehicle becomes suitable for the vehicle to run with the 2nd shift stage because of an increase of the accelerator opening degree, the control device firstly controls the second engaging member S2 of the second switching clutch 30B to be engaged with the clutch hub L so as to establish the 2nd shift stage. Secondly, the control device switches the dual clutch 12 from the first frictional clutch C1 to the second frictional clutch C2 so that the vehicle is driven with the 2nd shift stage. Finally, the control device disengages the first engaging member S1 of the first switching clutch 30A from the clutch hub L so as to establish the condition for the 2nd shift stage indicated in FIG. 3. Likewise, when the vehicle is driven in the condition suitable for the vehicle to run with the 3rd shift stage, the control device selects the shift stage appropriate to the condition of the vehicle, and also switches the dual clutch 12 to the first frictional clutch C1 from the second frictional clutch C2. Similarly, when the condition of the vehicle becomes suitable for the vehicle to run with the 4th shift stage, the control device selects the shift stage appropriate to the condition of the vehicle, and also switches the dual clutch 12 to the second frictional clutch C2 from the first frictional clutch C1.

When the condition of the vehicle becomes suitable for the vehicle to run with the 5th shift stage, the control device firstly controls the fifth engaging member S5 of the fourth switching clutch (switching clutch) 30D to be engaged with the clutch hub L, and further the control device connects the first input shaft 15 and the output shaft 19 so as to establish the 5th shift stage. Secondly, the control device switches the dual clutch 12 to the first frictional clutch C1 from the second frictional clutch C2 so that the vehicle is driven with the 5th shift stage. Finally, the control device controls the fourth engaging member S4 of the second switching clutch 30B to be disengaged from the clutch hub L so as to establish the condition for the 5th shift stage indicated in FIG. 3. In this case, the driving torque of the driving shaft 11 is transmitted to the output shaft 19 via the first frictional clutch C1, the first input shaft 15 and the fifth engaging member S5 of the fourth switching clutch 30D. Likewise, when the condition of the vehicle becomes suitable for the vehicle to run with the 6th shift stage, the control device firstly engages the sixth engaging member S6 of the third switching clutch 30C with the clutch hub L so as to establish the 6th shift stage. Secondly, the control device switches the dual clutch 12 to the second frictional clutch C2 from the first frictional clutch C1 so that the vehicle is driven with the 6th shift stage. Finally, the control device disengages the fifth engaging member S5 of the fourth switching clutch 30D so as to establish the condition for the 6th shift stage indicated in FIG. 3. In this case, driving torque of the driving shaft 11 is transmitted from the second frictional clutch C2 to the output shaft 19 via the second inputs shaft 16, the 6th shift stage gear train (25a, 25b), the third switching clutch 30C, the second counter shaft 18 and the second reduction gear train (29a, 29b).

When the condition of the vehicle becomes suitable for the vehicle to run with the 7th shift stage, the control device of the dual clutch transmission apparatus firstly controls the seventh engaging member S7 of the fourth switching clutch 30D to be engaged with the clutch hub L so as to establish the 7th shift stage. Secondly, the control device switches the dual clutch 12 to the first frictional clutch C1 from the second frictional clutch C2 so that the vehicle is driven with the 7th shift stage. Finally the control device controls the sixth engaging member S6 of the third switching clutch 30C to be disengaged from the clutch hub L so as to establish the condition for the 7th shift stage indicated in FIG. 3. When the vehicle is driven with the 6th shift stage or the 7th shift stage, the speed of rotation of the output shaft 19 becomes faster than that of the driving shaft 11. Additionally, when the condition of the vehicle becomes suitable for the vehicle to run with a low shift stage because of the speed of the vehicle decreases from a certain condition, the control device selects either the first frictional clutch or the second frictional clutch in turns as well as switching gear trains appropriate to the condition of the vehicle.

As described above, switching of the each switching clutch (the first switching clutch 30A, the second switching clutch 30B, the third switching clutch 30C and the fourth switching clutch 30D) corresponding to changes of shift stages is completed under a condition that the dual clutch 12 is switched to either the first frictional clutch C1 or the second frictional clutch C2, and that the dual clutch 12 is disengaged from either the first or the second frictional clutches C1, C2 (for example, when the dual clutch 12 is switched to the first frictional clutch C1, the second frictional clutch C2 is disengaged from the dual clutch 12, and vice versa) so that torque is transmitted to one of the switching clutches (30A, 30B, 30C and 30D) used to establish the shift stage appropriate to the condition of the vehicle. In other words, because the switching of the switching clutches (30A, 30B, 30C and 30D) is completed when either the first frictional clutch C1 or the second frictional clutch C2 is disengaged so that torque is not transmitted to the disengaged clutch, a shift operation for each shift stage in the transmission can be smoothly implemented.

Once a shift lever of the dual clutch transmission apparatus is set to a reverse shift operation position in a situation where the vehicle has stopped with the engine 10 being active, the control device detects the aforementioned state of the vehicle and, as shown in reverse condition in FIG. 3, engages the reverse engaging member SR of the third switching clutch 30C with the clutch hub L so that the other switching clutches are located in a neutral position. As a consequence, the reverse shift stage is formed. Once a rotational speed of the engine 10 exceeds a predetermined low rotational speed in response to an increase in an accelerator opening degree, the control device gradually increases an engagement force of the first frictional clutch C1 of the dual clutch 12 in accordance to an amount of the accelerator opening degree. Accordingly, torque of the driving shaft 11 is transmitted from the first clutch C1 to the output shaft 19 via the first input shaft 15, the reverse shift stage gear train (27a, 27b, 27c and 27d, the driving gear 27a is commonly used by the driving gear 21a of the first shift stage gear train), the reverse engaging member SR of the third switching clutch 30C, the second counter shaft 18 and the second reduction gear train (29a, 29b). As a result, the vehicle starts moving in a rearward direction.

When the shift lever is set to the parking range while the vehicle is temporarily stopped, the control device detects the aforementioned state of the vehicle, and then engages the first engaging member S1 of the first switching clutch 30A with the clutch hub L via a spring and at the same time, the control device engages the reverse engaging member SR of the third switching clutch 30C with the clutch hub L, as shown in FIG. 3. However, as an internal spline of the first switching clutch 30A may not align with an external spline of the first engaging member S1, both are not engaged immediately with each other. Similarly as an internal spline of the third switching clutch 30C may not align with an external spline of the reverse engaging member SR, both are not engaged immediately with each other. Therefore, the output shaft 19, which is connected to the driving wheels, remains rotatable. When a brake is loosened and the output shaft 19 connected to the driving wheels rotates further, firstly, the external spline of one of the engaging members S1 and SR is aligned with the internal spline of the sleeve M corresponding to the one of the engaging members S1 and SR by the sleeve M moving towards the one of the engaging member S1 and SR so that the one of engaging member S1 and SR is engaged with the sleeve M. As a result, the one of the engaging members S1 and SR is engaged with the clutch hub L via the spring in order to transmit the rotational torque to the driving gear (21a, 27a), and then the driving gear (21a, 27a) is rotated in one direction. The driving gear is a common gear that forms the driving gear 21a and the driving gear 27a and is fixed to the first input shaft 15, and the driving gear contacts with the 1st shift stage gear train (21a, 21b) and the reverse shift stage gear train (27a, 27b, 27c and 27d). Secondly, when the output shaft 19 is further rotated, the external spline of the other one of the engaging members S1 and SR is aligned with the internal spline of the sleeve M corresponding to the other one of the engaging member S1 and SR by the sleeve M moving towards the other one of the engaging member S1 and SR, in order to rotate the driving gear (21a, 27a) in opposite direction. By doing so, the driving gear (21a, 27a) is meshed with the driven gear 21b and simultaneously with the driven gear 27b. As a result, the 1st shift stage gear train and the reverse shift stage gear train are meshed together via the driving gear (21a, 27a), and at the same time, the first reduction gear train and the second reduction gear train are meshed together via the driven gar (28b, 29b).

In the above-mentioned embodiment, a parking lock operation is completed by meshing the gear trains (21a, 21b and 28a, 28b) used for transmitting torque to establish the 1st shift stage with the gear trains (27a, 27b, 27c, 27d and 29a, 29b) used for transmitting torque to establish a reverse shift stage. Therefore, a parking lock function may be added to the dual clutch transmission apparatus without providing additional components for the parking lock mechanism to the vehicle. Hence, the number of parts used for the parking lock mechanism is reduced. As a result, lowering production costs may be realized.

In the above-mentioned embodiment, the reduction gear ratio, which is established by transmitting torque through a pathway between the first input shaft 15 and the output shaft 19 including the 1st shift stage gear train (21a, 21b), is large. Likewise, the reduction gear ratio, which is established by transmitting torque through a pathway between the first input shaft 15 and the output shaft 19 including the gear train for reverse operation (27a, 27b, 27c and 27d), is large. A sign that indicates the direction of rotation of the 1st shift stage pathway is described opposite from the sign that indicates the direction of rotation of the reverse shift stage pathway. Therefore, in a case where torque is transmitted from the output shaft 19 to the first input shaft 11 through the 1st shift stage pathway and the reverse shift stage pathway, the torque is reduced by being transmitted through the both pathways, at the same time, rotating speeds established in the both pathways become larger and the rotational direction of the 1st shift stage pathway becomes opposite to the rotational direction of the reverse shift stage pathway. Additionally, under a condition where one of the engaging member S1, which is provided on the 1st shift stage pathway, and the engaging member SR, which is provided on the reverse shift stage pathway, is not engaged, and where the torque is transmitted from the output shaft 19 to the input shaft 11, relative rotating speed between the disengaged engaging member S1 or SR and the sleeve M, which corresponds to the disengaged engaging member S1 or SR, will be large.

As mentioned above, the reduction gear ratios of the 1st shift stage pathway and the reverse shift stage pathway between the first input shaft 15 and the output shaft 19 are large. Therefore, when the torque is transmitted from the output shaft 19 to the first input shaft 15, the torque is reduced by being transmitted through the 1st shift stage pathway and the reverse shift stage pathway, which results in reducing loads applied to the teeth portion of the driving gear (21a, 27a) provided at the first input shaft 15. The driving gear (21a, 27a) is commonly used by the 1st shift stage gear train and the reverse shift stage gear train. By the same tokens the loads applied to the teeth portions of the engaging members S1 and SR are reduced. Additionally, as the rotating speed of the first input shaft 15 becomes larger than the rotating speed of the output shaft 19, the rotating speed of the driving wheels becomes smaller until either the engaging member S1 or the engaging member SR is engaged. Then the relative rotating speed between the disengaged engaging member (either the engaging member S1 or SR) and the sleeve M, corresponding to the disengaged engaging member, becomes larger. As a result, rotating speed of the driving wheels until the other one of the engaging members S1 and SR is engaged will also be reduced. Hence, distance of the moving vehicle, from when the parking lock operation is operated to when the parking lock operation is completed, will be shortened, and the speed of the vehicle during the parking lock operation will also be reduced. Therefore, during the parking operation, due to an inertia of the vehicle, the impact loads applied to the teeth portion of the driving gear (21a, 27a) provided on the first input shaft 15 will be reduced. By the same token, the impact loads applied to the teeth portions of the engaging members S1 and SR will also be reduced. Additionally, by transmitting torque from the output shaft 19 to the first input shaft 15, the torque is decreased, which also decreases loads applied to the teeth portions of the driving gear (21a, 27a), the engaging member S1 and the engaging member SR. Hence, chances of the teeth portions of the driving gear (21a, 27a), the engaging member S1 and the engaging member SR being damaged will be reduced.

In the above-mentioned embodiment, a gear, which is provided on the first input shaft 15, is commonly used by the 1st shift stage driving gear 21a and the reverse shift stage driving gear 27a. By doing so, the number of the gears is reduced and the structure of the parking lock mechanism is simplified. The present invention is not limited to the above-mentioned embodiment, but also it may be realized by providing the 1st shift stage driving gear 21a and the reverse shift stage driving gear 27b individually.

According to the embodiment of the present invention, the parking lock operation is completed by engaging the engaging member of the 1st shift stage with the clutch hub and, at the same time, engaging the engaging member of the reverse shift stage with the clutch hub. A driving gear, which is commonly used by the 1st shift stage gear train and the reverse shift stage gear train, is meshed with a driven gear of the 1st shift stage gear train and simultaneously meshed with a driven gear of the reverse shift stage gear train, as a result, the parking lock operation is completed. Hence, the parking lock mechanism can be added to the dual clutch transmission apparatus without providing additional and particular components.

According to the embodiment of the present invention, the reduction gear ratio, which is established between the output shaft and one of the input shafts, is large. A gear that comprises the 1st shift stage gear train is provided at the one of the input shafts. Also, the reduction gear ratio, which is established between the output shaft and the other input shaft, is large. A gear that comprises the reverse shift stage gear train is provided at the other one of the input shafts. The sign indicating rotational direction of the gear provided at the one input shaft is described the other way around from the sign indicating rotational direction of the gear provided at the other input shaft. Therefore, in a case where torque is transmitted from the output shaft to the input shaft, the torque, which is transmitted through the 1st shift stage gear train and the reverse shift stage gear train to the first input shaft, is reduced. At the same time, the rotational speeds of the 1st shift stage gear train and the reverse shift stage gear train are both increased. The rotational direction of the 1st shift stage gear train rotates in the opposite direction from the rotational direction of the reverse shift stage gear train. In a case where one of the engaging members, which are provided at the 1st shift stage gear train and the reverse shift stage gear train respectively, is in a disengagement state, and where the torque is transmitted from the output shaft to the input shaft, the relative rotating speed between the disengaged engaging member and a sleeve M, which corresponds to the disengaged engaging member, will be large. In the present invention, during the parking lock operation, each of the engaging members is not engaged immediately with the clutch hubs that correspond to each of the engaging members. When the output shaft connected to the driving wheels slightly rotates, one of the engaging members is engaged with the clutch hub, and when the output shaft rotates further more, the other one of the engaging members is engaged with the clutch hub corresponding to the other engaging member. As a result, the driving gear is meshed with the driven gear of the 1st shift stage gear train and simultaneously with the driven gear of the reverse shift stage gear train, so that the parking operation is completed. The driving gear is commonly used by the 1st shift stage gear train and the reverse shift stage gear train.

During the parking lock operation, as mentioned above, the reduction gear ratio between the one of the input shaft and the output shaft is reduced. Also, the reduction gear ratio between the other input shaft and the output shaft is reduced. The rotational direction of the one input shaft is the other way around from the rotational direction of the other input shaft. Therefore, loads applied to teeth portions of the each gear, which is provided to the each input shaft, are reduced. On the other hand, because the rotating speed of the input shaft is larger than the rotating speed of the output shaft, a distance the moving vehicle, from when the parking lock operation is operated to when the parking lock operation is completed, is shortened. Therefore, during the parking lock operation, the speed of the vehicle is also decreased. Hence, during the parking operation, due to an inertia of the vehicle, the impact loads applied to the teeth portion of each gear provided on the one of the input shafts, will be reduced. As mentioned above, the loads applied to the teeth portions of the each gear provided at the one of the input shaft will be considerably reduced because of 1) an effect of the reduction gear ratio; 2) an effect of reducing the rotating torques by the rotation of, for example, 1st shift stage gear train being rotated in the opposite direction from the rotation of the reverse shift stage gear train; and 3) an effect of reducing the speed of the vehicle during the parking lock operation. Hence, chances of the teeth portions of the each gear and of the engaging members being damaged are reduced.

According to the embodiment, a gear is provided at one of the input shafts. The gear is commonly used by the 1st shift stage gear train and the reverse shift stage gear train. Therefore, the member of the gears used to realize the parking lock mechanism is reduced. Moreover, the structure of the parking lock mechanism may be simplified.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather that restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

1. A dual clutch transmission apparatus with a parking lock function, comprising:
a first input shaft;
a second input shaft arranged coaxially with the first input shaft;
a first counter shaft arranged in parallel with the first and the second input shafts;
a second counter shaft arranged in parallel with the first and second input shafts;
a dual clutch including a first clutch and a second clutch, the first clutch transmitting rotational torque from a power source to the first input shaft and the second clutch transmitting the rotational torque from the power source to the second input shaft;
a first gear change mechanism provided between the first and the second input shafts and the first counter shaft and having first plural gear trains;
the first plural gear trains including a 1st shift stage gear train;
a second gear change mechanism provided between the first and the second input shafts and the second counter shaft and having second plural gear trains;
the second plural gear trains including a reverse shift stage gear train;
an output shaft connected to the first and the second counter shafts for transmitting the rotational torque from the power source to a driving wheel;
a first gear provided at one of the first and second input shafts and forming the 1st shift stage gear train;
a second gear provided at one of the first and second input shafts and forming the reverse shift stage gear train;
a plurality of engaging members each provided in connection with each of the shift stage gear trains and being in engaged/disengaged state in order to switch torque transmission of the each shift stage gear train;
the plurality of engaging members including a first engaging member being in an engaged state in order to transmit torque at the 1st shift stage gear train; and
the plurality of engaging members including a reverse engaging member being in an engaged state in order to transmit torque at the reverse shift stage gear train, wherein, during a parking operation, the first engaging member and the reverse engaging member are in the engaged states simultaneously so that a parking lock is executed.

2. The dual clutch transmission apparatus with the parking lock function according to claim 1, wherein the first gear and the second gear is formed by a single common gear provided at one of the first input shaft and the second input shaft.
